(19) United States
(12) Patent Application Publication
(10) Pub. No.: US 2006/0199143 A1
(43) Pub. Date: Sep. 7, 2006

(54) Systems and methods for replicating positions of a mandible

(76) Inventor: William Shawn Lopez, Boca Raton, FL (US)

Correspondence Address: AKERMAN SENTERFITT, P.O. BOX 3188, WEST PALM BEACH, FL, 33402-3188, US

(21) Appl. No.: 11/366,262

(22) Filed: Mar. 2, 2006

Related U.S. Application Data
(62) Division of application No. 10/407,605, filed on Apr. 4, 2003.
(60) Provisional application No. 60/443,493, filed on Jan. 29, 2003.

(51) Int. Cl. A61C 3/00; A61C 11/00

(52) U.S. Cl. 433/24; 433/57

(57) ABSTRACT

A mandible alignment system for aligning a model of a mandible relative to an axis of rotation to substantially replicate the orientation of the mandible relative to an axis of rotation. The mandible alignment system may include aligning an axis formed between a point on a first retro molar pad of a model of a mandible with a point on a second retro molar pad of the model with an axis of rotation of a device. The axis formed between the retro molar pads of the mandible may be oriented to be parallel, or substantially parallel, to the axis of rotation of the device along the Z-axis and the X-axis. The mandible alignment system also includes numerous devices for facilitating alignment of the model of the mandible with the axis of rotation of the device.

### CROSS-REFERENCE TO RELATED APPLICATION

This application is a divisional application of United States Utility Patent Application Ser. No. 10/407,605, filed Apr. 4, 2003, which claims the benefit of U.S. Provisional Application No. 60/443,493, filed Jan. 29, 2003.

### FIELD OF THE INVENTION

This invention is directed generally to dental devices and methods, and more particularly to systems and methods for replicating a position of a mandible in a patient using models of at least a portion of the mandible.

### BACKGROUND

Prosthetic components are often created by first creating impressions of portions of a mandible and maxilla that are exposed in the mouth of a patient and the teeth, if any, that are coupled thereto. The impressions are used to record the size, shape, and other details of a patient's jaw structure. Conventional impressions taken of patients do not record the location of the retro molar pads in the patients. Models of a patient's mandible and maxilla are then made using the impressions. Typically, a material such as plaster is poured into the impression. After the plaster has solidified, the model may be removed from the impression. The model is a substantial replication of the mandible or maxilla of the patient.

The models are then typically coupled to an articulator. An articulator, as shown in FIG. 2, is a device that substantially resembles the shape and function of a jaw. A typical body is often formed from two opposing arms that are generally parallel to each other and generally orthogonal to the portion of the base configured to hold the model of the mandible. The base may also include an arm rotatably coupled to the base. The arm may be configured to hold a model of a maxilla. The arm is also typically slidably mounted to the articulator to replicate the protrusive action of the mandible. A spring biased shaft is often used to keep the arm engaged to the body and to increase the force necessary to rotate the arm relative to the base. Articulators may also include a device for limiting the rotation of the arm relative to the body to record the position of the mandible and maxilla of the patient when the patient's mouth is in a closed position.

Typically, the models of the mandible and the maxilla are coupled to an articulator using a plaster or other material. A model of a mandible is typically aligned, if at all, relative to the articulator by a dental technician placing the mandible on the body of the articulator. A facebow, as shown in FIG. 1, may be used to align the model of the mandible. However, a facebow is not extremely accurate. A facebow is an instrument that attempts to record the location of the mandibular condyles of a patient using probes that are configured to fit on each side of a patient's head proximate to the mandibular condyles. However, positioning the probes accurately is easier said than done. While the mandibular condyles are near the outside surface of a human head, a layer of skin, muscle, and other tissue are positioned between the probe and the mandibular condyle. Thus, accurately determining a location on one condyle that is symmetric with a location identified by an opposing probe of the facebow is very difficult.

After the model of the mandible is placed on the articulator, the model is attached to the articulator with a plaster material. A model of a maxilla is then often attached to the rotatable arm by placing a wax rim corresponding to a patient on the model. The wax rim includes an impression taken from the patient and represents the position of the mandible relative to the maxilla of the patient when the patient's mouth is in a closed position. After the wax rim has been placed on the model of the mandible, the model of the maxilla is attached to the wax rim. The arm is then attached to the maxilla while the maxilla remains in contact with the wax rim and thus in correct anatomical position relative to the model of the mandible. A threaded rod is positioned to record the position of the rotatable arm when the models of the maxilla and the mandible are in the closed position. Once the model of the maxilla has been securely connected to the articulator, the wax rim is removed. The models may then be moved relative to each other, but are prevented from contacting each other. Rather, the models may only be closed to a point resembling a closed position.

A denture may be formed using the models coupled to the articulator by forming a base from an acrylic material. The base is configured to fit closely to the model of the mandible or the maxilla and is configured to fit around the various protrusions and other abnormalities that may exist in the patient's mouth. The base may also include a rim, which is typically formed from a wax material, and the rim is configured to retain teeth to the base. The dentures are positioned on models of the mandible and the maxilla coupled to the articulator, and the teeth are positioned in the rim. The position of the upper and lower teeth are often controlled using a Spee curve template. The template facilitates placing the outermost surfaces of the teeth in a curved plane when viewed from the side of the models. The amount of curve in the plane may vary. After the teeth have been positioned, the prototype dentures are placed into the patient's mouth. Adjustments may be made if the dentures do not fit correctly. After the dentures have been adjusted to the patient's satisfaction, the dentures are placed in final form using conventional systems known to those of ordinary skill in the art.

This method typically produces dentures having one or more teeth with outermost surfaces not lying in the occlusal table of the patient. Such a misaligned configuration can result in numerous negative implications. For instance, a misaligned denture often causes irritation and swelling in the affected area. A misaligned denture may also cause the alveolar ridge to migrate. Migration of the alveolar ridge often times negatively affects the comfort of the patient using the denture. In other situations, a misaligned denture may cause other negative side affects to a patient, such as migraine or stress related headaches.

Thus, a need exists for a system for more accurately replicating the position of a mandible relative to a maxilla and the orientation of the mandible relative to an axis of rotation.

### SUMMARY OF THE INVENTION

This invention relates to a system, referred to as the mandible alignment system, for replicating the position of a mandible and maxilla relative to each other and relative to an axis about which the mandible rotates in a human, using models of the mandible and the maxilla. By replicating the position of the mandible and the maxilla relative to each other and to an axis of rotation, the majority of guesswork associated with creating dentures, crowns, bridges, and other dental implants is substantially, if not completely, eliminated. The mandible alignment system uses fixed positions on the mandible, which may also be referred to a landmark anatomy, to align a model of a mandible with an axis of rotation. The mandible alignment system may also include mandible support devices for positioning models of a mandible and a maxilla relative to each other and relative to an axis of rotation. The mandible support devices may include an alignment device and, in some embodiments, an axis identification device.

The mandible alignment system is directed, in part, to a method for positioning models of a mandible and a maxilla relative to an axis of rotation, which replicates a position of the mandible and the maxilla in the patient for which the models represent. In particular, the mandible alignment system is directed to a method for positioning a model of a mandible in relation to an axis of rotation. In one embodiment, the method includes creating a model of a mandible of a patient including the retro molar pads of the patient. The model of the mandible may be positioned relative to an axis of rotation by first identifying an axis formed between a point on a first retro molar pad of a model of a mandible of a patient and a point on a second retro molar pad of the model. The points used as reference points may be the uppermost point on each retro molar pad, or may be other points on the pads that are symmetric with respect to each other. Once the axis between the retro molar pads has been identified, the model of the mandible may be aligned with an axis of rotation of a mandible support device. The mandible support device may be any device capable of securely positioning models of a mandible and a maxilla while allowing one or both of the models to rotate relative to each other about an axis of rotation. In at least one embodiment, the mandible support device may be an articulator. In other embodiments, the mandible support device may be an improved articulator.

A model of a mandible may be aligned with an axis of rotation using any device capable of identifying an axis between the retro molar pads of a model. Once the axis between the retro molar pads has been located, the model may be rotated about the Z-axis until the axis between the retro molar pads of the model is parallel, or substantially parallel, with the axis of rotation of the device. The model of the mandible may be positioned relative to the X-axis. In at least one embodiment, a device, such as, but not limited to, a rod, may be used to position the model relative to the axis of rotation about the X-axis. The rod may be positioned along the midline of the patient and along the Z-axis. When viewed parallel to the X-axis, the rod forms a crosshair with the axis formed between the retro molar pads. This configuration may be used to facilitate orientation of the model about the X-axis and may be referred to as crosshair referencing. The model of the mandible may be oriented about the Y-axis, which is also referred to as the anterior/posterior tilt, so that the mandible is positioned in a position similar to the position of the mandible in the patient and relative to an axis of rotation. Aligning a model of a mandible in this manner does not position the model a correct distance from the axis of rotation, which in a patient is the axis formed between the ends of the mandibular condyles. Rather, the model is positioned in correct alignment with an axis of rotation representing the axis of rotation in a patient formed between the mandibular condyles.

Once the model of the mandible has been oriented, the model may be coupled to the device using conventional methods and materials. A model of a maxilla of a patient may be coupled to the device in a position relative to the model of the mandible and to the axis of rotation that replicates the position of the maxilla in the patient. A fitting may be used to facilitate positioning the model of the maxilla by first placing the fitting on the model of the mandible. The fitting is a device used to take an impression of the mandible and the maxilla of the patient when the patient's mouth is in a closed position. The model of the maxilla may then be placed into the fitting, which orients the model of the maxilla relative to the model of the mandible. The model of the maxilla may then be coupled to the device using conventional methods and materials. The position of the models relative to each other may be recorded using a rotation limiting device, which may be a threaded shaft or other device. The rotation limiting device is not limited to this embodiment, but may be any device for recording the position of the devices relative to each other.

In this position, the models of the maxilla and the mandible may be used for a variety of purposes, including, but not limited to: diagnosis; analysis of dentures; modification of dentures; creation of dentures; determination of proper placement of crowns, bridges, and other dental implants; or for other purposes. One or more dentures may be created by positioning a prototype denture formed from a base having a rim on the model of the maxilla or the model of the mandible, or on both. The base and rim of the denture may be formed using convention materials and methods. An occlusal table may be located by using a template configured to follow the general layout of teeth on a human jaw. The template may be curved and represent a Spee curve. The Spee curve may be positioned at various angles as known to those of ordinary skill in the art. The occlusal table may be located by positioning a template substantially in the plane formed by the uppermost points on the retro molar pads of the model of the mandible and a smile line of the patient as recorded on the fitting. The smile line may be the position of a lower edge of an upper lip of a patient when the patient is in full smile relative to the position of the mandible when the mandible is in a closed position.

Teeth may be installed in the rim of the denture. The upper anterior incisal teeth may be positioned so that about ⅔ of the visible front surface of each tooth is positioned below the smile line. In at least one embodiment, the distance from the lower incisal edge of the upper anterior teeth may be about 6 millimeters. Installation of the anterior teeth may be facilitated by splitting the fitting in half along the midline of the fitting and removing about half of the fitting. This allows the teeth to be placed in the rim of the maxillary denture in a known position relative to the smile line of the patient. After about three teeth have been installed into the rim, the remaining portion of the fitting may be removed to facilitate installation of the remaining anterior teeth. The anterior teeth may be installed into the rim. The lower teeth, which may be fourteen in number, may then be installed in the denture for the mandible, if necessary. The uppermost surfaces of the teeth can be positioned to lie in the occlusal table identified as being in the plane formed by the retro molar pads and the lower edge of the upper anterior teeth. The height and Spee curve of the lower teeth may be controlled using a Spee curve template. The remaining upper teeth may be installed in the maxillary denture. The position of these upper teeth may be checked using the uppermost surfaces of the teeth connected to the mandibular denture and the Spee curve template.

The mandible alignment system may also be used to diagnose pain, soreness, irritation, headaches, and other problems that a patient may be experiencing. These problems may be associated with misaligned dentures, dental implants, or other devices. The mandible alignment system may be used for diagnosis purposes by creating models of a patient's mandible and maxilla, as previously described, and positioning the models relative to an axis of rotation, as also previously described. The dentures may then be placed on the models and analyzed. By correctly positioning dentures on models in correct alignment with an axis of rotation, problems with position, alignment, tilt, and other variables of the teeth become apparent. The dentures may then be adjusted or recreated as necessary.

In one situation, a misaligned denture may cause headaches, such as, but not limited to, migraine or stress induced headaches, in a patient. For example, if a denture is misaligned so that the first teeth to contact each other between the upper and lower teeth are the molars on one side of the mouth, the opposing side of the mandible and the mandible itself may pivot around the point of contact. This movement may cause the mandibular condyle on the side of the mandible opposite from the pivot point to repeatedly impart a damaging force on the mandibular fossa. This damaging force may be transferred to the bundle of nerves positioned proximate to the mandibular fossa. Unnecessarily contacting this bundle of nerves as a result of the mandible pivoting about the point of contact may be one of the factors for forming headaches, such as migraine headaches and stress induced headaches in some patients.

The mandible alignment system may use numerous devices for positioning models of a mandible and a maxilla in correct anatomical position relative to each other and relative to an axis of rotation. In at least one embodiment, the mandible alignment system may use any device capable of securely holding a model of either a mandible or a maxilla and enabling the model to be rotated about an axis of rotation. The device may be formed from a body having an arm coupled to the body and capable of rotating about an axis of rotation. The device may also include an alignment device coupled to the body for positioning a model of a mandible on the device so that an axis formed between a point on a first retro molar pad and a point on a second retro molar pad is parallel, or substantially parallel, to an axis of rotation of the device.

The alignment device may be formed from numerous configurations. For instance, the alignment device may be a shaft that is not connected to the device. The shaft may be used to identify the axis between the retro molar pads by being held in position by a human, or an adhesive or other material. The shaft may be aligned with an axis of rotation of the device without the use of instruments or outside aides. In other embodiments, the shaft may be coupled to the device for positioning and holding models of a mandible and a maxilla. In particular, the shaft may be aligned with the axis of rotation using two or more filaments. The filaments may be coupled to the device through various manners and may be fixedly or releasably coupled to the shaft.

In other embodiments, the alignment device may be formed from one or more arms. In one embodiment, the alignment device may have a single arm and may be configured to identify the axis between the retro molar pads. The arm may be configured to identify the axis using the arm itself or by using a shaft that may be releasably or fixedly coupled to the arm. In one embodiment, the arm may have one or more receptacles for receiving a shaft so that the shaft is parallel, or substantially parallel, to the axis of rotation of the device. The shaft may be formed integrally with the arm or may be coupled to the arm.

In other embodiments, the alignment device may include two or more arms. The arms may be configured to rotate about the body in unison. The arms may be coupled together with a shaft for identifying the axis formed between the retro molar pads. In another embodiment, each of the two arms may include a relatively short shaft for identifying the axis between the retro molar pads. The shafts may or may not contact each other. In yet another embodiment, the arms may include one or more orifices for receiving a device, such as a shaft, for identifying the axis between the retro molar pads. These embodiments and others are described in more detail below.

### BRIEF DESCRIPTION OF THE DRAWINGS

The accompanying drawings, which are incorporated in and form a part of the specification, illustrate embodiments of the presently disclosed invention and, together with the description, disclose the principles of the invention.

FIG. 1 is a perspective view of a facebow.

FIG. 2 is a perspective view of an articulator.

FIG. 3 is a perspective view of a model of a mandible including the retro molar pads.

FIG. 4 is a perspective view of an impression tray for recording retro molar pads.

FIG. 5 is a front view of a patient with a fitting in the patient's mouth and a smile line made on the fitting.

FIG. 6 is a perspective view of mandible support device having a model of a mandible attached thereto with a shaft identifying an axis between a point on a first retro molar pad and a point on a second retro molar pad.

FIG. 7 is a front view of the mandible support device of FIG. 6 together with a rod positioned along a midline of the patient and forming a crosshair reference.

FIG. 8 is a side view of the mandible support device with a fitting resting on the model and an occlusal table identified;

FIG. 9 is a frontal perspective view of a mandible support device having a model of a mandible and a model of a maxilla attached;

FIG. 10 is a rear perspective view of the embodiment shown in FIG. 9.

FIG. 11 is side view of a mandible support device in a closed position with a partial fitting attached.

FIG. 12 is a perspective view of a mandible support device having models of a mandible and a maxilla attached and showing a Spee curve template positioned between the models for aligning the teeth in the dentures.

FIG. 13 is a perspective view of a denture without teeth.

FIG. 14 is a perspective view of a mandible support device having a single tooth installed in the maxillary denture.

FIG. 15 is a perspective view of a mandible support device having a plurality of upper anterior incisors installed in the maxillary denture.

FIG. 16 is a perspective view of a mandible support device having a plurality of upper anterior incisors installed in the maxillary denture and a plurality of lower teeth installed in a mandibular denture.

FIG. 17 is a perspective view of a mandible support device having a plurality of teeth installed in the maxillary and mandibular dentures.

FIG. 18 is a top view of a mandible having a contact point on a molar.

FIG. 19 is a side view of a patient's skull showing movement of the mandible during mastication with improper fitting dentures.

FIG. 20 is a front view of a mandible support device having an alignment device coupled to mandible support device using filament.

FIG. 21 is a front view of a mandible support device having an alignment device coupled to mandible support device angled filament.

FIG. 22 is a front view of a mandible support device having an alignment device coupled to mandible support device using at least one arm.

FIG. 23 is a front view of a mandible support device having an alignment device coupled to mandible support device using two arms.

FIG. 24 is a front view of a mandible support device having an alignment device coupled to mandible support device using at least one axis locating device.

FIG. 25 is a perspective view of a mandible support device having an alignment device coupled to mandible support device using at least one arm having orifices for receiving a shaft.

FIG. 26 is a perspective view of a mandible support device having an alignment device coupled to mandible support device using at least one arm having indentations for receiving a shaft.

FIG. 27 is a front view of a mandible support device having an alignment device supported by a base positioned proximate to the mandible support device.

FIG. 28 is a front view of a mandible support device having an alignment device supported by a base positioned proximate to the mandible support device.

FIG. 29 is a perspective view of a mandible support device having an alignment device coupled to the mandible support device above the mandible and not to the axis of rotation of the mandible support device.

FIG. 30 is an alternative embodiment of a mandible support device.

FIG. 31 is another alternative embodiment of a mandible support device.

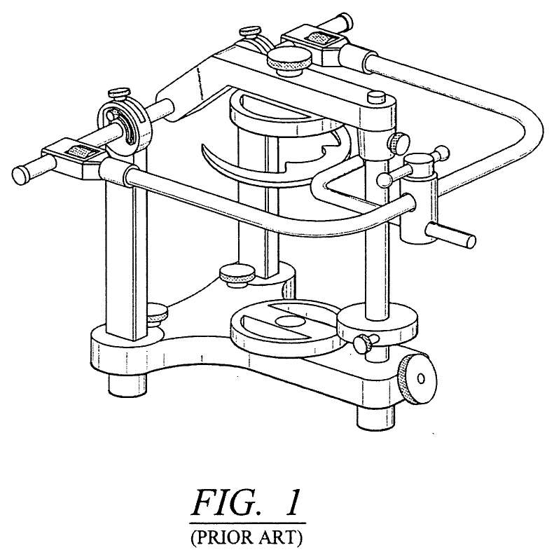

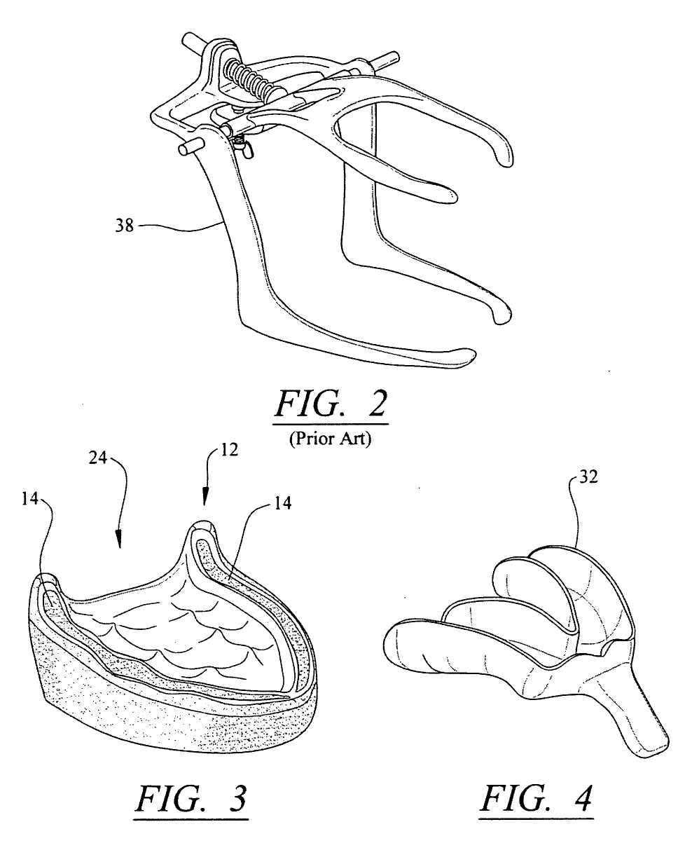

### DETAILED DESCRIPTION OF THE INVENTION

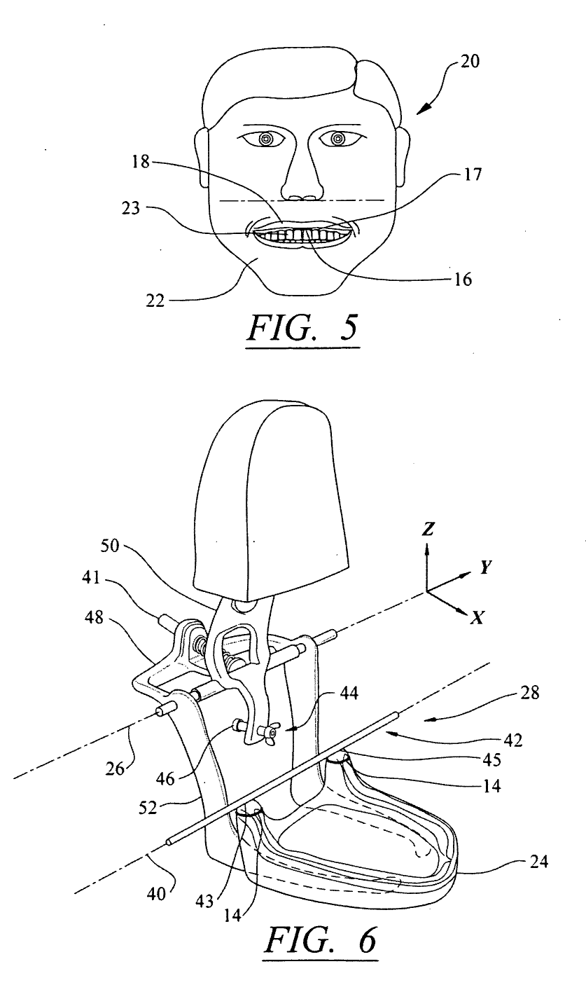

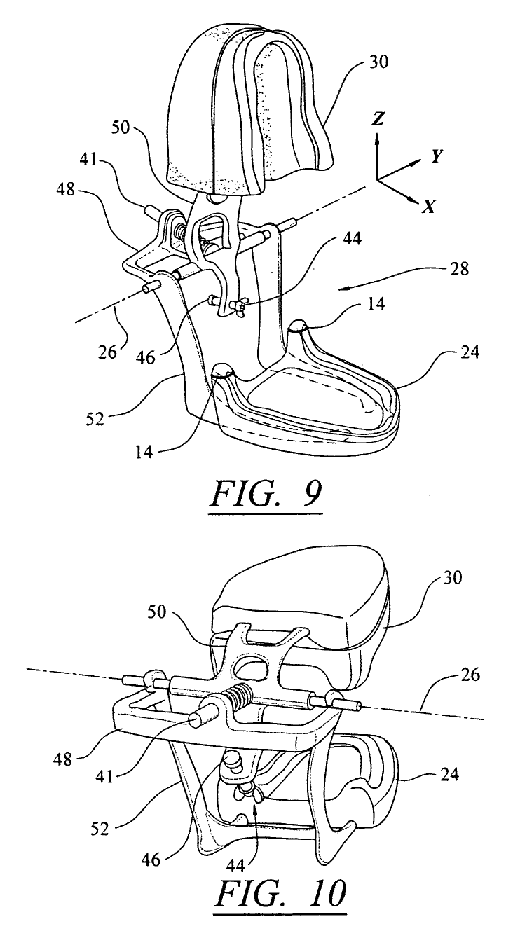

This invention is directed to a mandible alignment system 10, as shown in FIGS. 3-31, for replicating alignment of a mandible of a human in relation to an axis of rotation about which the mandible rotates, which may be the axis formed by the mandibular condyles of a patient, using landmark anatomy 12. Landmark anatomy 12 may include, but is not limited to, retro molar pads 14, and a smile line 16. The smile line 16 may be the position of a lower edge 17 of an upper lip 18 of a patient 20 when the patient is in full smile relative to the position of the mandible 22 when the mandible is in a closed position. Mandible alignment system 10 may be used to facilitate proper alignment of a model 24 of at least a portion of a mandible relative to an axis of rotation 26 of a mandible support device 28. Mandible alignment system 10 includes methods for correctly aligning models of a mandible 24 and a maxilla 30 of a patient, and devices for facilitating the process of aligning the models.

A method of mandible alignment system 10 may include, in part, making an impression of a portion of mandible, making a model of the mandible 24 from the impression, and aligning the model of the mandible relative to an axis of rotation 26 of a mandible support device 28. The process of replicating the structure of a patient's mouth first entails making an impression of the patient's mouth. The portions of the maxilla 23 and mandible 22 from which an impression may be taken include those portions found within a patient's mouth, including all natural occurring and prosthetic teeth that may be coupled, either directly or indirectly, to the maxilla and mandible of a patient 20. The impressions may be taken from the flesh covered portions of the maxilla 23 and mandible 22 accessible in the mouth of a patient.

An impression of the patient's maxilla 23 and mandible 22 may be taken in manners known to those of ordinary skill in the art and may be made in one or more steps. However, while taking an impression of the patient's mandible 22, the impression may also take an impression of the retro molar pads 14 found on each side of a patient's mandible 22 proximate to the posteriormost molar. The step of taking the impression may include making a first impression, which is often referred to as a preliminary impression. The materials used to take the preliminary impression may be materials known to those of ordinary skill in the art.

The preliminary impression may be used to form another device, which may be referred to as a tray 32. The tray 32, as shown in FIG. 4 enables a second impression to be taken that is capable of recording more detail from the patient than is often available from the preliminary impression. If the location of the retro molar pads 14 was not recorded in the preliminary impression, the location of the retro molar pads may be approximated while forming the tray 32. The location may be approximated using for instance, and not by way of limitation, modeling clay, putty, or other materials. By approximating the location and size of the retro molar pads 14 in forming the tray 32, more accurate information, such as the correct size, configuration, and location of the retro molar pads, may be gathered while using the tray. After the tray 32 has been formed for a particular patient, the tray may be used to take an impression from the patient in manners substantially similar to those methods used to take the preliminary impression. Trays 32 may be used to take an impression of a maxilla or a mandible of a patient.

The trays 32 may then be used to form models of a patient's maxilla and mandible. A model of the mandible 24 preferably shows the retro molar pads 14 on the mandible, as shown in FIG. 3. The trays 32 may be formed from various materials, such as, but not limited to conventional materials, such as mortar and plaster, and other materials.

A fitting 34, as shown in FIG. 8, may be used to record the position of the mandible 22 and the upper teeth on the maxilla 23 relative to the mandible when a patient's mouth is in a closed position. The fitting 34 may be a conventional wax rim. Alternatively, the fitting 34 may be formed from other materials, such as, but not limited to, heat softened materials, and other pliable materials. In addition, the fitting 34 may be used to record a midline 36 of a patient's head, a smile line 16, and other information. The smile line 16 may be marked by placing a physical mark on the fitting 34, by marking the fitting with a writing instrument, such as a marker, or through other methods. If the upper lip 18 of the patient 20 is disfigured, the approximate location of a lower edge 17 of a normal upper lip should be marked on the fitting 34. The location of the smile line 16 may also vary according to a patient's opinion.

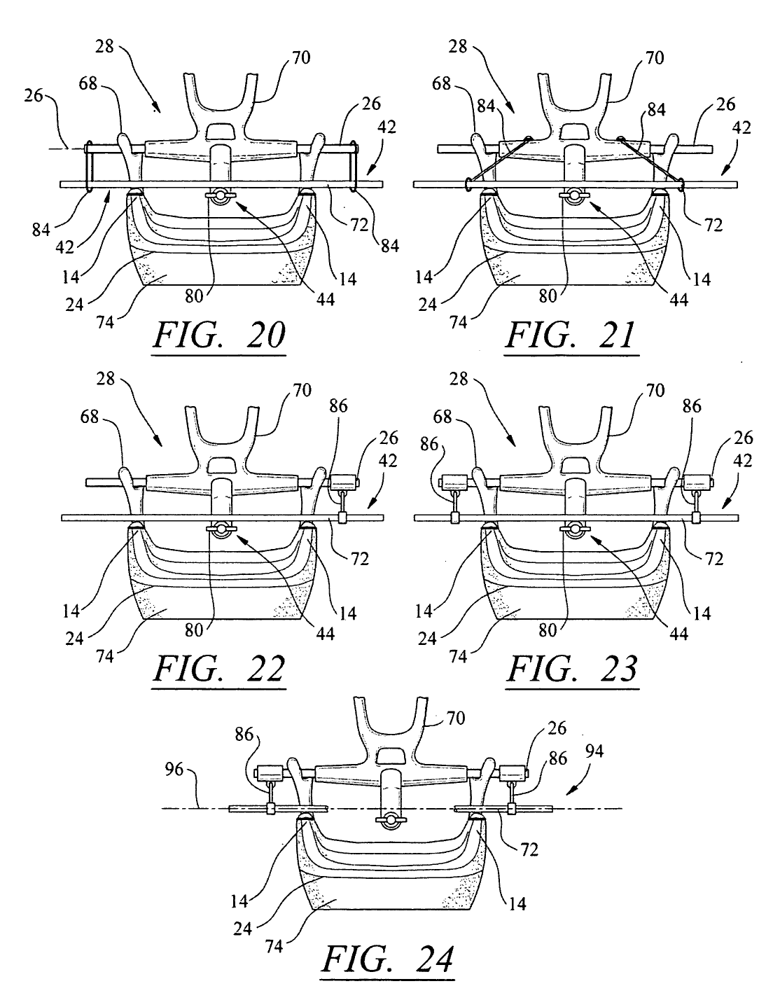

A model of a mandible 24 may be aligned with an axis of rotation 26 of a mandible support device 28. The mandible support device 28 may be capable of holding models of the mandible and the maxilla 24 and 30 in position relative to each other while enabling at least one of the models to rotate about the Y-axis, as shown in FIG. 6, with respect to the other model. In one embodiment, the mandible support device 28 may be an articulator 38. The articulator 38 may have any configuration capable of allowing at least one of the models 24 or 30 to rotate about the Y-axis, as shown in FIG. 6, relative to the other model. Mandible alignment system 10 is not limited to being used with a conventional articulator 38. Rather, the mandible support device 28 may be any device capable of securely holding the models 24 and 30 in position relative to each other and to an axis of rotation 26. Embodiments of the mandible support device 28 configured to facilitate alignment of model of a mandible 24 the are shown in FIGS. 20-31 and described below. These examples are not shown for purposes of limitation, rather as examples.

While the mandible support device 28 supports a model of a mandible 24 and facilitates alignment of the model with an axis of rotation 26, the mandible support device may or may not position the retro molar pads 14 of the model at a distance from the axis of rotation of the mandible support device that is equal to a distance from the retro molar pads 14 in a patient to an axis formed between condyles in the patient. Instead, mandible alignment system 10 replicates a symmetric relationship between each retro molar pad 14 and an axis of rotation formed between condyles of a patient. In most patients 20, a distance from a first condyle and a retro molar pad on one side of a patients head is equal, or substantially equal, to a distance from a second condyle and a second retro molar pad one an opposing side of the patient's head. Thus, positioning the retro molar pads 14 of a model of a mandible 24 at a distance from an axis of rotation 26 of a mandible support device 28 equal to a distance between the retro molar pads and an axis of rotation between a patient's condyles from which the model resembles is not critical. Rather, aligning a model of a mandible 24 in correct rotational relationship relative to an axis of rotation 26 is important for replicating the alignment of a patient's mandible 22 relative the patient's maxilla 23.

For example, a model of a mandible 24 of a patient 20 may be aligned with an axis of rotation 26 of an articulator 38, as shown in FIG. 6. More specifically, the model of the mandible 24 may be aligned with an axis of rotation 26 by first identifying an axis 40 formed by a point 43 on a first retro molar pad 14 on one side of the model of a mandible 24 and a point 45 on a second retro molar pad 14 on an opposing side of the model. In one embodiment, the points 43 and 45 on each retro molar pad 14 may be the uppermost points on the pads, as shown in FIG. 6. Alternatively, the points 43 and 45 may be at the bottom of the pads 14 or anywhere in between the uppermost points and the bottom of the pads 14 as long as the points on each pad are symmetric with respect to each other. The axis 40 may be identified using any alignment device 42 capable of establishing an axis 40 between the points 43 and 45 and enabling the model of the mandible 24 to be aligned with the axis of rotation 26 of the mandible support device 28 so that the axis between the points on the retro molar pads 14 are parallel to, or at least substantially parallel to, the axis of rotation of the mandible support device. In one embodiment, the alignment device 42 may be a rod for identifying the axis 40 and for aligning the axis formed between the retro molar pads 14 with the axis of rotation 26 of the mandible support device 28. The rod may or may nor be coupled to the mandible support device 28. This embodiment and others are discussed in more detail below.

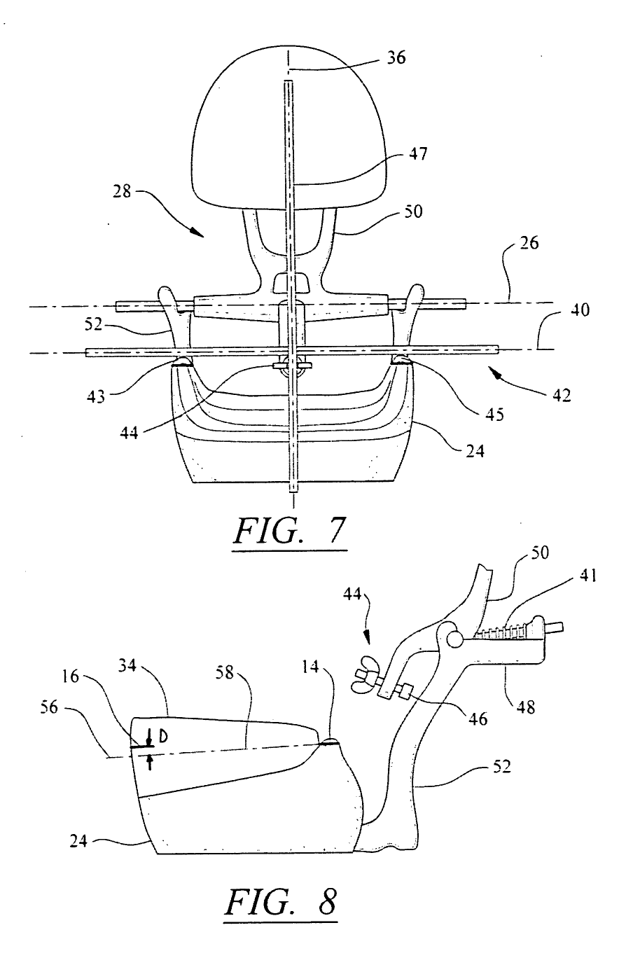

Once the axis 40 between the retro molar pads 14 has been identified, the model of the mandible 24 is rotated about an X-axis, as shown in FIGS. 6-7, so that the axis between the retro molar pads 14 is parallel to, or substantially parallel to, an axis of rotation 26 of a mandible support device 28 about the X-axis. Rotation of the model of the mandible 24 in this manner may be facilitated by using a rod 47 placed along the midline 36 of the model and generally orthogonal to the axis 40 formed between the retro molar pads 14. The midline 36 may represent the middle of the patient's face and may be recorded using the fitting 34. The rod may facilitate correct alignment of the model relative to the X-axis. Use of this rod may be referred to as crosshair referencing.

The model may also be rotated about the Z-axis so that the axis 40 between the retro molar pads 14 is parallel to, or substantially parallel to, the axis of rotation 26 or the axis 40 established between the retro molar pads 14, or both. The model of the mandible 24 may be positioned relative to the Z-axis using a midline 40 of the model of the mandible 24. The model of the mandible 24 may be positioned relative to the Z-axis so that the midline 36 of the model parallel to the X-axis is positioned orthogonal, or substantially orthogonal, to the axis of rotation 26 of the mandible support device 28.

The anterior/posterior tilt of the model of the mandible 24 may vary about the Y-axis. In one embodiment, the model of the mandible 24 may be rotated so that the model rests in a position as shown in FIG. 8. The model of the mandible 24 may be positioned so that when the fitting 34 used to record the location of a patient's smile line 16 is placed on the model, the plane formed by the retro molar pads 14 and the smile line 16 is parallel, or substantially parallel, to a surface upon which the mandible support device rests. However, the model of the mandible 24 is not limited to being placed in this position relative to the Y-axis. Rather, the model of the mandible 24 may be aligned in other positions relative to the Y-axis.

The model of the mandible 24 is then attached to the mandible support device 28. The model of the mandible 24 may be attached to the mandible support device 28 using conventional methods and materials known to those of ordinary skill in the art. For instance, the model of the mandible 24 may be secured to the mandible support device 28 using plaster or other materials attached to the bottom side of the model of the mandible or to other portions of the model, as long as the upper aspects of the model are not inhibited.

The model of the maxilla 30 may be attached to the mandible support device 28 by first positioning the fitting 34 on the model of the mandible 24, as shown in FIG. 8. The model of the maxilla 30 may then be placed onto the fitting 34. By placing the model of the maxilla 30 onto the fitting 34, the relationship of the patient's mandible 22 to the patient's maxilla 23 may be replicated. After the model of the maxilla 30 has been placed onto the fitting 34, the model of the maxilla 30 may be coupled to the mandible support device 28 using conventional methods and materials known to those of ordinary skill in the art.

While the fitting 34 is positioned between the mandible and maxilla models 24 and 30 and the models are positioned relative to each other simulating a fully closed position of a patient's mouth, a rotation limiting device 44, as shown in FIG. 6, may be adjusted to record the position of the models relative to each other when the models are in a fully closed position. The rotation limiting device 44 may be any device capable of recording the position at which the model of the mandible 24 and the model of the maxilla 30 rest relative to each other. In one embodiment, as shown in FIG. 6, the rotation limiting device 44 may be a threaded rod having an end for contacting an opposing arm to limit movement of the arm to a position in which the models of the mandible and the maxilla would be closer to each other than in the fully closed position. Rotation limiting device 44 may include a spring biased plunger 41 for limiting movement of the arm 50 and for enabling mandible support device 28 to be moved protrusively, which is generally along the X-axis. The rotation limiting device 44 is not limited to this configuration, but may include other configurations as well.

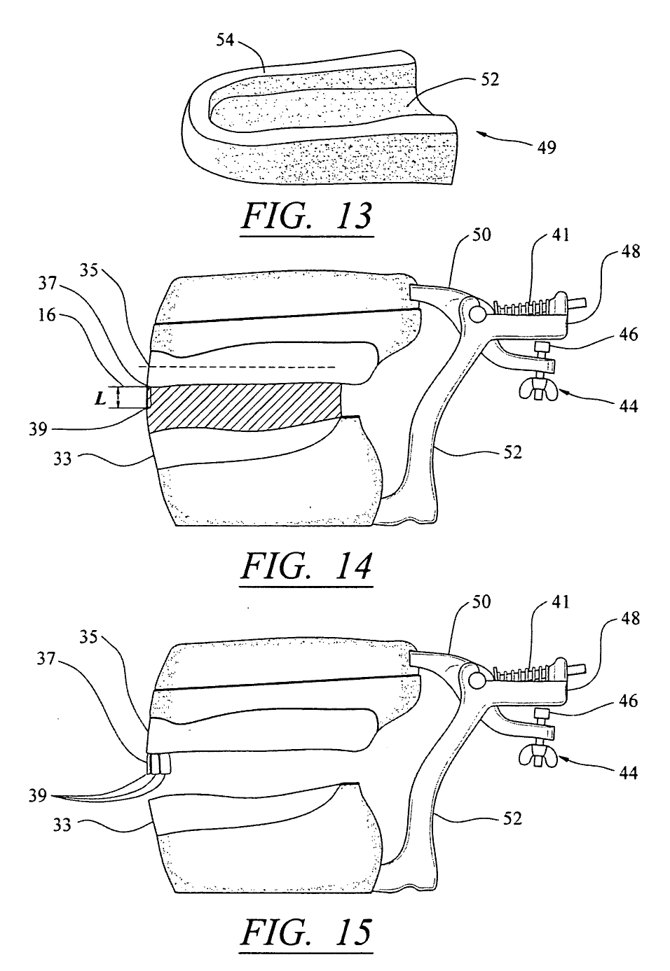

Once the models of the mandible and the maxilla 24 and 30 have been secured to the mandible support device 28, the models may be used to for a variety of purposes, including, but not limited to: diagnosis; analysis of dentures; modification of dentures; creation of dentures; determination of proper placement of crowns, bridges, and other dental implants; or for other purposes. For instance, the models 24 and 30 positioned on the mandible support device 28 may be used to create dentures. In one embodiment, dentures 49, as shown in FIG. 13, may be created by first forming the denture base using at least one of the models in manners known to those of ordinary skill in the art. In particular, a base 52 may be formed using a material such as, but not limited to, acrylic.

A rim 54 formed from a pliable material for coupling teeth to the base 52 may then be coupled to the base. The pliable material may be, but is not limited to, a wax. The denture 49 formed from the base 52 and the rim 54 may be installed on the model that the base was configured to resemble. Teeth may be installed in the rim 54. If the rim 54 is formed from a wax, the wax may be heated, if necessary, to install the teeth in the rim. In one embodiment, as shown in FIGS. 14-17, where a mandibular denture 33 and a maxillary denture 35 are formed, teeth 37 may be first installed in the maxillary denture 35. For instance, about six upper anterior teeth may be installed in the rim 54, as shown in FIG. 14. The vertical position of the teeth 37 may be determined using the smile line 16 of the patient 20 that has been recorded on the fitting 34. The teeth 37 may be positioned in the rim 54 so that about ⅔ of the length of each tooth, L, exposed from the rim 54 to the outermost edge 39 of the upper anterior incisal teeth 37 are below the smile line 16, as shown in FIG. 14. However, the length of the exposed portion of the teeth 37 exposed may vary, which may depend on the size of the tooth positioned in the rim, opinions of the patient 20, and other factors. The exposed portion of a typical adult tooth used to form dentures may vary between about seven millimeters to about ten millimeters, with a more common length being about nine millimeters. Thus, the length of the exposed portion of the teeth extending below the smile line 16 may vary between about 4⅔ millimeters and about 6⅔ millimeters, and preferably about six millimeters. These dimensions are provided by way of example and should not be interpreted as limitations.

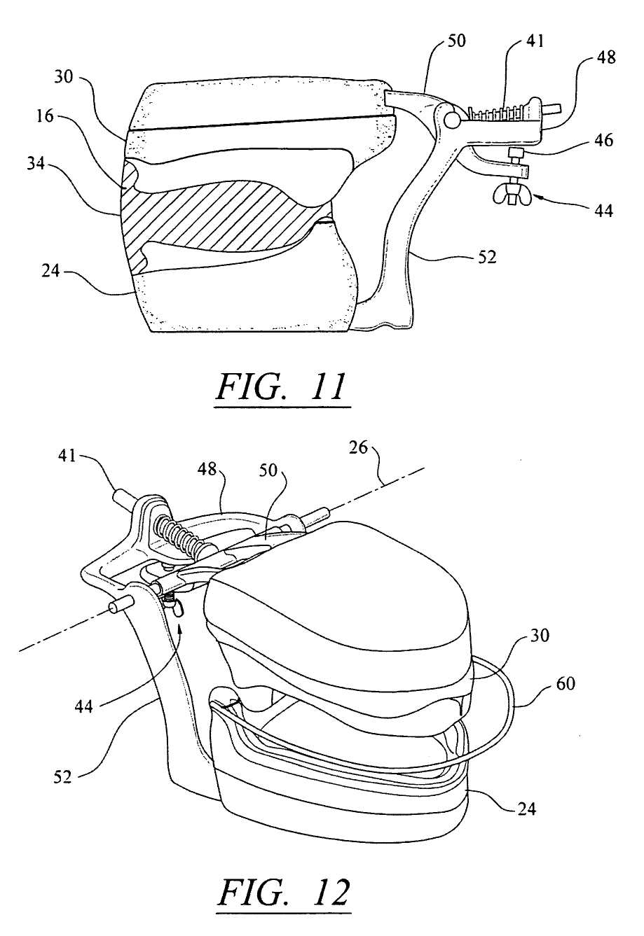

The process of installing teeth in the rim 54 may be facilitated by using the fitting 34 to determine the position of the smile line 16 relative to the model of the maxilla 30. However, use of the fitting 34 filling all of the space between the models 24 and 30 prevents installation of teeth while the fitting 34 is in place. Thus, the fitting 34 may be modified to enable teeth to be installed in the rim 54 while the fitting is in place. In one embodiment, about half of the fitting 34 may be removed from the fitting generally along the midline of the fitting. The half fitting 34, as shown in FIG. 11 and 14, can be used to establish the position of the smile line 16 relative to the model of the maxilla 30 while allowing one or more teeth to be installed using the smile line 16 as a reference point. A first tooth 37 may be installed in the rim 54 by pushing the tooth into the rim. The length of the front surface of the tooth 37 visible beyond the rim 54 can be controlled using the smile line 16 as a reference. point, as shown in FIG. 14. The other variables, such as rotation, anterior/posterior tilt, and other variables may be taken into account with conventional methods known to those of ordinary skill in the art. For instance, the tooth 37 may be positioned relative to the rim 54 so that the tooth resembles the position of a naturally occurring tooth in the same location on the maxilla 23. Additional anterior teeth may be installed while the half fitting 34 is positioned between the models 24 and 30 or after the half fitting has been removed, as shown in FIG. 15. In one embodiment, six anterior teeth may be installed in the model of the maxilla 30.

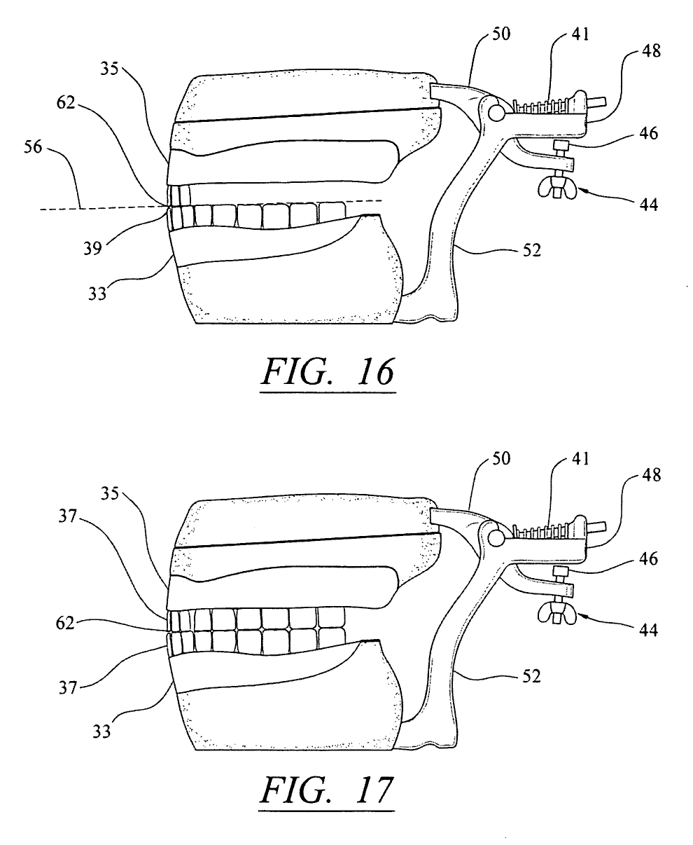

After the upper anterior teeth 37 have been installed into the rim 54, the half fitting 34 may be removed, if it has not already been removed. Teeth 37 may be installed in the model of the mandible 24, as shown in FIG. 16. The teeth 37 may be installed by pressing the teeth into the rim 54 on the base 52 of the partially formed denture 49. The teeth 37 may be angled to resemble the position of a naturally occurring teeth in the same location on the mandible. The outermost surface 39 of the teeth 37 may be positioned to lie in the occlusal table 56 of the patient's mouth.

The occlusal table 56 may be identified to be in, or substantially in, a plane 58 formed by the axis 40 formed between the retro molar pads 14 and the lower edge 64 of the upper anterior teeth 66. As shown in FIG. 8, the lower edge 64 of the upper anterior teeth may be positioned a distance D from the smile line 16, which may be six millimeters. Distance D is not restricted to being six millimeters and may vary depending on the size of teeth chosen and the opinion of the patient 20. The outermost surface 39 of each tooth 37 may be positioned to lie within or substantially within this plane 58. The height of each lower tooth 37 relative to adjacent teeth 37 may be controlled using a template 60, as shown in FIG. 12. The template 60 may be substantially flat or may be formed at various angles representing a conventional Spee curve. The Spee curve template 60 may be formed at angles of 10°, 20°, 33°, and others. As the teeth are inserted into the rim 54, the template 60 may be used to correctly position the teeth in the rim relative to the occlusal table 56. After the remaining teeth have been placed in the mandibular denture 33, the remaining upper teeth 37 may be installed in the rim 54 of the maxillary denture 35, as shown in FIG. 17. The location of the outermost surfaces 39 of the upper teeth may be determined by using the template 60 and by closing the mandible support device 28, which hinges the models of the mandible 24 and the maxilla 30 together.

Once the teeth have been properly positioned in the rim 54, the dentures 49 may be placed in the patient's mouth to test whether the denture fits properly. If the denture 49 fits well and the patient 20 does not desire any modifications of the denture, the denture is processed according to conventional methods to transform the prototype into a denture having a more permanent structure. If the denture 49 requires some modification, the denture may be modified and then transformed into a more permanent structure.

The exist numerous modifications that can be made to a denture 49. For instance, the amount of tooth exposed in a maxillary denture 35 may be adjusted by pulling a tooth 37 out of the rim 54 or pushing the teeth into the rim, whichever is desired. If, for instance, the amount of visible surface of the upper teeth 37 is desired to be changed, the height may be changed to a limited extent without removing the outermost surface 39 of the teeth from the occlusal table 56 because the occlusal table may lie within in a plane 58 that may vary within about 4 millimeters in vertical position. Thus, the outermost surface 39 of the teeth 37 may be adjusted within this area without negative results occurring.

If when a denture 49 is installed in a patient, the lower incisal edge 62 of the upper anterior incisors forms a line that is not generally orthogonal to the midline 36 of the patient's face, then the angle of the teeth may be changed to correct the misalignment. Because the retro molar pads 14 are found in patients in a variety of sizes, widths, and lengths, and the mandible may include infringing tuberosities, and other complicating factors, identification of symmetrical points 43 and 45 on the retro molar pads 14 may be difficult to accurately complete. In the event where the teeth have been identified as being misaligned once the dentures have been trialed by the patient, the teeth may be realigned using the smile line 16 recorded on the fitting 34. In particular, the smile line 16 may be used to realign the mandibular model 24 with the axis of rotation 26 of the mandible support device 28. An alignment device 42, such as, but not limited to, a rod or other such device, as discussed below, may be used to be used to align the model of the mandible 24 about the X-axis. Specifically, the rod 42 may be rotated until the rod is parallel, or substantially parallel, to the axis of rotation 26 of the mandible support device 28. The maxillary model 30 may then be connected to the mandible support device 28 in the manner described above. Once the models 24 and 30 have been positioned on the mandible support device 28, the teeth may be realigned. The location of the occlusal table 56 maybe identified again using the template 60. The dentures may then be trialed by the patient 20 once again. The process may be completed once again if necessary.

In an alternative embodiment, the teeth may be realigned without first realigning the models of the mandible 24 or the maxilla 30. Rather, the teeth may be realigned using the smile line 16 by aligning the teeth to be generally orthogonal to the smile line. However, if the teeth need to be realigned and the amount of visible surface of the teeth above the rim 54 needs to be adjusted, the mandibular and maxillary models 24 and 30 are preferably realigned relative to the mandible support device 28 in order to reposition the teeth before the teeth are adjusted. The mandibular and maxillary models 24 and 30 may be realigned as discussed above.

As previously stated, mandible alignment system 10 may be used to analyze whether existing dentures were properly manufactured and to identify possible causes of discomfort originating from dentures or other dental work previously completed on a patient 20. Mandibular and maxillary models 24 and 30 may be aligned and coupled to a mandible support device 28 in the manner described above. The dentures may then be placed on the mandibular and maxillary models 24 and 30. It can then be determined whether the dentures are the cause of any problem, such as pain, traumatic tooth loss, temporomandibular joint dysfunction (TMJ), headaches, such as migraine headaches, stress induced headaches, or other discomfort that the patient may be experiencing.

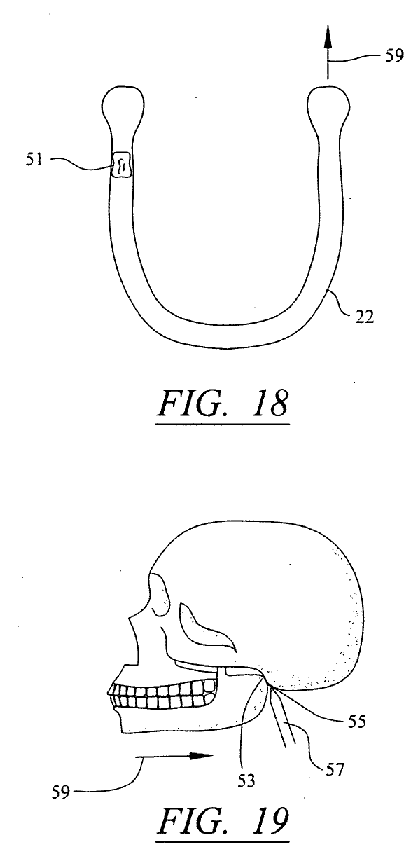

For example, as shown in FIG. 18, when teeth on a denture are misaligned and cause the denture coupled to a patient's mandible to first contact an opposing denture at a molar 51, rather than the mandibular and maxillary dentures meshing together, the mandibular denture may be prone to cause the mandibular denture and the mandible 22 to pivot about point of contact 51 towards the opposing retro molar pad 14 of the patient 20, as shown by arrow 59. Movement of a denture and mandible 22 is this manner may be a contributing factor of headaches, such as migraine headaches and stress induced headaches. For instance, such movement of the mandible 22, as shown in FIGS. 18 and 19, may cause the mandibular condyle 53 on the side of the mouth opposite the pivot point 51 to repeatedly contact the mandibular fossa 55 with inordinate amounts of pressure. This pressure may, in turn, be applied to the bundle of nerves 57 or skeletal structure located proximate to the mandibular fossa 55. Thus, ordinary mastication with dentures or fixture crowns and bridges misaligned in this fashion may cause the bundle of nerves 57, tissue surrounding the nerves, or skeletal structure to be irritated or stressed, which may induce a headache, such as a migraine headache or a stress induced headache.

Mandible alignment system 10 may also be used to aide in positioning or repositioning bridges, crowns, and other dental implants. It is preferable to position an outermost surface of a tooth, crown, bridge, or other implant in the occlusal table 56. Otherwise, the outermost surfaces of these members can bind with opposing teeth during mastication. Binding of teeth can impart a force to the opposing teeth and cause migration of the alveolar ridge. Positioning an outermost surface of a tooth in an occlusal table 56 may prevent or substantially prevent migration of the alveolar ridge on the mandible or maxilla, or both.

Dental implants may be analyzed by making models of the mandible 24 and maxilla 30 as described above. The models 24 and 30 may be installed on a mandible support device 28 as previously described. An occlusal table 56 may then be located along the plane 58 formed between the uppermost points on the retro molar pads 14 and a lower edge 64 of the upper anterior incisors 66. Identifying the occlusal table 56 enables an outermost surface of a tooth to be properly positioned within the occlusal table. Having knowledge of the proper location of the occlusal table 56 enables a bridge, a crown, or other dental implants to be positioned more accurately in a patient.

Mandible alignment system 10 may also include numerous mandible support devices 28, as shown in FIGS. 20-31, to replicate the function of the mandible 22 and alignment of the mandible relative to the maxilla 23. In at least one embodiment, mandible alignment system 10 may include a mandible support device 28 for aligning a model of a mandible 24 with an axis of rotation 26. For instance, as shown in FIG. 20, the mandible support device 28 may be formed from a body 68. The body 68 of the mandible support device 28 may or may not be self supporting. The body 68 may include at least one arm 70 capable of rotating about an axis of rotation 26. The arm 70 may be configured to support a mandibular or a maxillary model 24 or 30. In one embodiment, the arm 70 may be coupled to or include an integral shaft 72 for being rotatably coupled to the body 68. The arm 70 may include one or more connection mechanisms 74 for coupling a model of a mandible 24 or a maxilla 30 to the arm 70. The connection mechanism 74 may be have any configuration facilitating connection of a model to the arm 70.

The mandible support device 28 may include a second arm 76 configured to receive a model of a mandible or maxilla 24 or 30. In one embodiment, the second arm 76 may be configured to receive a model of a mandible 24. The second arm 76 may be movably or rigidly attached to the body 68. In one embodiment, the second arm 76 may be integrally formed with the body 68. The second arm 76 may also include a connection mechanism 74 for facilitating connection of a model to the second arm. The connection mechanism 74 may have any configuration facilitating connection of a model to the second arm.

The mandible support device 28 may also include a rotation limiting device 44. The rotation limiting device 44 may be any device capable of limiting the rotation of the second arm 76 about the axis of rotation 26. For instance, the rotation limiting device 44 may be a threaded rod coupled to the body 68 at a threaded aperture 78. The aperture 78 may be positioned in the second arm 76, as shown in FIG. 20. The threaded rod may be advanced or retreated from the aperture 78 to adjust the position of the model of the maxilla 30 relative to the position of the mandible 24 when in a closed position. A nut 80 may be screwed onto the threaded rod and positioned to contact the arm 76 to prevent the rotation limiting device 44 from moving. In other embodiments, the rotation limiting device 44 may be formed from a height adjustable stop. In yet another embodiment, the rotation limiting device 44 may be formed from a wedge or other similar device.

Mandible alignment system 10 may also include an alignment device 42. The alignment device 42 may be coupled to the body 68 for positioning a mandibular model 24 so that an axis 40 formed between a point 43 on a first retro molar pad 14 of the model and a point 45 on a second retro molar pad 14 of the model is parallel, or substantially parallel, to the axis of rotation 26 of the mandible support device 28. The alignment device 42 may be formed from numerous embodiments, some of which are shown in FIGS. 20-31.

As shown in FIGS. 20-31, the alignment device 42 may include one or more shafts 72. The shaft 72 may or may not be coupled to the body 68. In at least one embodiment, the shaft 72 may be coupled to the body 68 using two or more filaments 84, as shown in FIGS. 20 and 21. Each filament 84 is coupled to the shaft 72 and to the body 68 so that the shaft is parallel, or substantially parallel, to the axis of rotation 26 of the mandible support device 28. In one embodiment, the shaft 72 is made to be parallel to the axis of rotation 26 by using two or more filaments 84 having an identical length. Each of the filaments 84 may be formed from the same or different materials. The filaments 84 may be a monofilament or a multifilament. In addition, the filament 84 may be formed from plastics, yarn, nylon, or other suitable materials.

In another embodiment, as shown in FIGS. 22-24, the alignment device 42 may include one or more arms 86. As shown in FIG. 22, the alignment device may be formed from a single arm 86 used to align the axis 40 formed between the retro molar pads 14 with the axis of rotation 26 of the mandible support device 28. Alternatively, the arm 86 may be configured to include one or more shafts 72 coupled to the arm. The shaft 72 may be positioned parallel, or substantially parallel, to the axis of rotation 26. The shaft 72 may also be slidably coupled to the arm 86, which may enable the shaft to be moved radially closer to or further from the axis of rotation 26, depending on the location of a model of a mandible 24 relative to the mandible support device 28 and the size and shape of the retro molar pads 14 on the model. The arms 86 may be rotatably coupled to the body 68 of the mandible support device 28 so that the shaft 72 may be rotated, yet remain parallel, or substantially parallel, to the axis of rotation 26.

In yet another embodiment, the alignment device 42 may include two or more arms 86, as shown in FIGS. 23 and 24. The arms 86 may be rotatably coupled to the body 68 of the mandible support device 28. The arms 86 may be configured to be coupled together so that the arms rotate in unison about the body 68. The arms 86 may be coupled together through the configuration of the arms 86 themselves, using one or more shafts 72, or using another device, or any combination thereof.

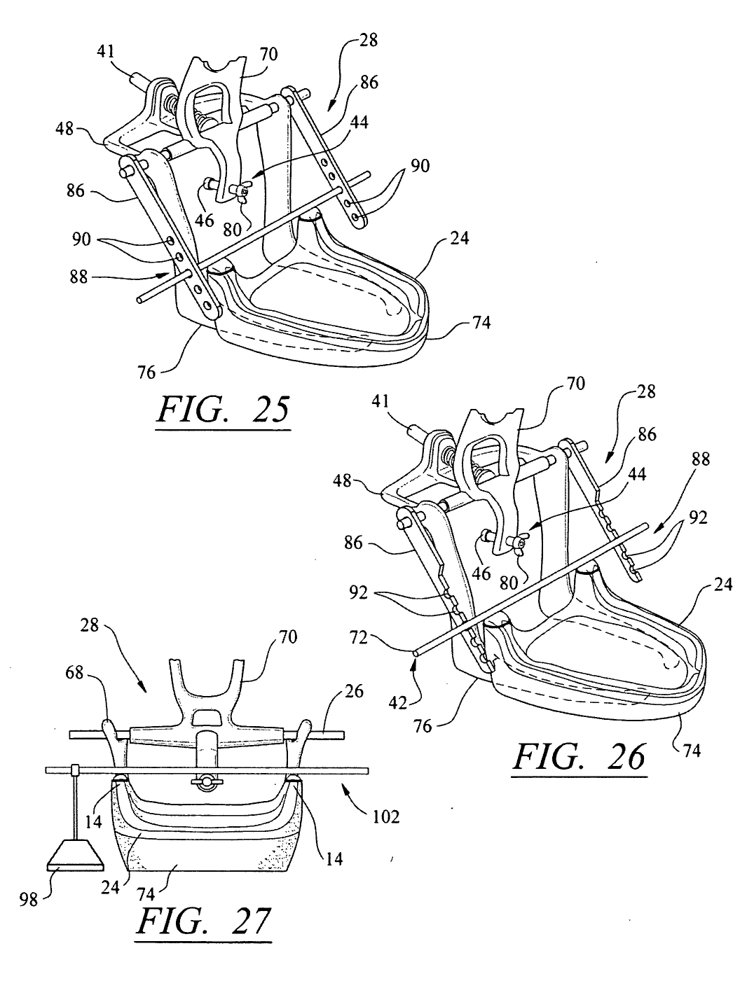

As shown in FIGS. 25 and 26, the arms 86 may include receptacles 88 for holding a shaft 72. More specifically, the arms 86 may be configured to releasably support one or more shafts 72. The receptacles 88 may be one or more orifices 90 in the arms 86 that are configured to receive the shaft 72, as shown in FIG. 25. The receptacles 88 may also be one or more indentations 92 in the arms 86 and sized to receive a shaft 72, as shown in FIG. 26.

As shown in FIG. 24, the arms may be configured to include an axis locating device 94 coupled to the arms 86 for locating symmetric points 43 and 45 on the retro molar pads 14 of a model of a mandible 24. The axis location device 94 may be composed of a shaft 72, or other device, having a relatively short length coupled to each arm 86. In other embodiments, axis locating device 94 may be formed from a pointer or other such device. The shafts 72 preferably are positioned along the same axis 96. Alternatively, the axis locating device 94 may be an integrally formed with the arms 72.

Alignment device 42 need not be fixedly coupled to the mandible support device 28; but, may be free standing. One or more embodiments of the alignment device 42, as shown in FIGS. 27-31 are configured to be capable of being positioned in relation to the mandible support device 28 so that an axis 40 identifiable through use of the alignment device 42 may be placed parallel, or substantially parallel, to an axis of rotation 26 of the mandible support device 28. The alignment device 42 may be formed from a base 98. The base 98 may or may not be freestanding. In other words, the base 98, in some embodiments, may be required to be attached to the mandible support device 28 to properly function, while in other embodiments, the base 98 may operate without relying on the body 68 of the mandible support device 28 for support. The base 98 may include one or more orientation points 100 for aligning the alignment device 42 with the mandible support device 28. The orientation point 100 may be any device for aligning the base 98 of the alignment device 42 with the mandible support device 28. For instance, and not by way of limitation, the orientation point 100 may be a sharp point, shaft, or other device on the alignment device 42 that may be received by a small orifice on the mandible support device, or vice versa. In another embodiment, the alignment device 42 may include two or more orientation points 100 for facilitating proper orientation of the alignment device relative to the axis of rotation 26 of the mandible support device 28.

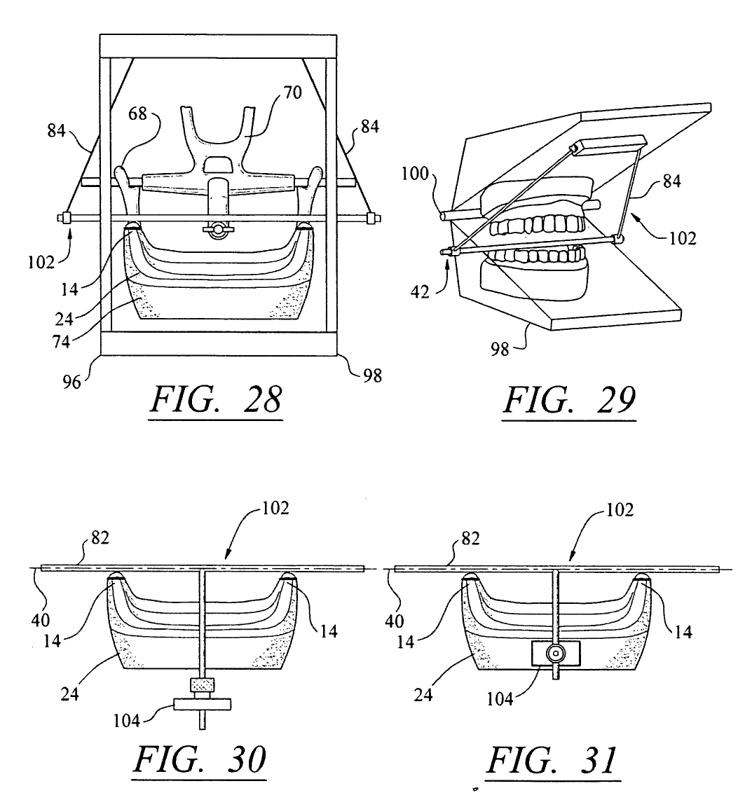

As shown in FIGS. 28 and 29, alignment device 24 maybe suspended from base 98 from a point above a model of a mandible 24. A shaft 72 may be coupled to base 98 using one or more filaments 84, using any one or combination of devices shown in FIGS. 20-27 and 30-31, or other devices.

In these embodiments of the alignment device 42 where the alignment device is not a fixed part of the mandible support device 28, the alignment device 42 may include an axis identification device 102 for identifying an axis 40 between the retro molar pads 14 of a mandibular and maxillary model 24 and 30 and aligning the axis 40 with an axis of rotation 26 of the mandible support device 28. The axis identification device 102 may be any of the devices previously described and shown in FIGS. 20-27. For instance and not by way of limitation, the axis identification device 102 may be formed from one or more arms, shafts, filaments, or other devices, or any combination thereof.

As shown in FIG. 30 and 31, axis identification device 102 may be one or more device configured to be coupled to a model of a mandible 24. As shown in FIG. 30, axis identification device 102 may include an adjustable shaft 104 that may be coupled to mandible support device 28. Adjustable shaft 104 may support one or more shafts 72 for identifying axis 40. As shown in FIG. 31, adjustable shaft 104 may be configured to be coupled to a model of a mandible 24.

The foregoing is provided for purposes of illustrating, explaining, and describing embodiments of this invention. Modifications and adaptations to these embodiments will be apparent to those skilled in the art and may be made without departing from the scope or spirit of this invention.

I claim:

1. A method of replicating a position of a human mandible relative to an axis of rotation of an articulating device, comprising:
identifying an axis formed between a point on a first retro molar pad of a model of a mandible of a patient and a point on a second retro molar pad of the model;
aligning the axis formed between the retro molar pads with the axis of rotation of the articulating device about an X-axis of the articulating device.

2. The method of claim 1, positioning the model of the mandible so that a midline of the model is substantially perpendicular with the axis of rotation about an X-axis.

3. The method of claim 1, positioning the model of the mandible so that a midline of the model is substantially perpendicular with the axis of rotation about a Y-axis.

4. The method of claim 1, coupling the model of the mandible to the articulating device.

5. The method of claim 1, further comprising forming a model by taking an impression of a patient's mandible including a first retro molar pad of the patient and a second retro molar pad of the patient.

6. The method of claim 5, wherein forming the model further comprises taking a first impression of a patient's mandible including a first retro molar pad of the patient and a second retro molar pad of the patient; forming a tray for taking a second impression; taking a second impression of a patient's mandible including a first retro molar pad of the patient and a second retro molar pad of the patient.

7. The method of claim 1, further comprising coupling the model of a patient's mandible to the articulating device so that an axis formed between a point on a first retro molar pad of the model and a point on a second retro molar pad of the model is substantially parallel to the axis of rotation of the articulating device;
coupling a model of the patient's maxilla to the articulating device so that the model of the maxilla fits together with the model of the mandible in a manner substantially similar to the manner in which the mandible and maxilla of the patient close together in the patient.

8. The method of claim 7, wherein coupling the model of the patient's maxilla to the articulating device so that the model of the maxilla fits together with the model of the mandible further comprises inserting a fitting into a patient's mouth to record the position of teeth, a mandible, and a maxilla relative to each other, positioning the fitting on the model of the mandible, and positioning the model of the maxilla in the fitting.

9. The method of claim 7, further comprising determining a position of an occlusal table relative to the models of the mandible and the maxilla.

10. The method of claim 9, wherein determining the position of the occlusal table further comprises identifying a plane formed by the point on the first retro molar pad of the model of the mandible, the point on the second retro molar pad of the model of the mandible, and a point indicating a lower edge of at least one central incisor in the maxilla.

11. The method of claim 10, further comprising positioning at least one tooth in the base of the appliance so that an outermost surface of the at least one tooth mates with an outermost surface of an opposing tooth at the occlusal table.

12. The method of claim 10, wherein the point indicating a lower edge of at least one central incisor in the maxilla is located by identifying a location of a patient's smile line and moving from the patient's smile line toward the mandible a distance equal to a height of upper incisors desired to be visible while the patient is smiling.

13. The method of claim 12, wherein the distance equal to a height of upper incisors desired to be visible while the patient is smiling is equal to about ⅔ of a length of a tooth extending from an appliance.

14. The method of claim 12, wherein the distance equal to a height of upper incisors desired to be visible while the patient is smiling is equal to about six millimeters.

15. The method of claim 10, wherein determining the position of the occlusal table further comprises positioning a Spee curve template between the maxilla and the mandible.

16. The method of claim 12, further comprising creating an appliance, installing the appliance in the patient's mouth, determining whether the appliance fits correctly, and adjusting teeth if necessary.

17. The method of claim 16, further comprising repositioning the model of the mandible relative to the axis of rotation if a rotational orientation and a vertical position of the at least one tooth are desired to be changed.

18. The method of claim 17, wherein repositioning the model of the mandible further comprises aligning a smile line of the patient marked on a fitting to be substantially parallel with the axis of rotation of the device.

19. A method of replicating a position of a human mandible relative to an axis of rotation of an articulating device, comprising:
taking an impression of a patient's mandible including a first retro molar pad of the patient and a second retro molar pad of the patient;
forming a model of the mandible using the impression, wherein the model of the mandible includes a first retro molar pad and a second retro molar pad;
identifying an axis formed between a point on the first retro molar pad of a model of a mandible of a patient and a point on the second retro molar pad of the model;
aligning the axis formed between the retro molar pads with the axis of rotation of the articulating device about an X-axis of the articulating device.

20. The method of claim 19, coupling the model of the mandible to the articulating device so that a midline of the model is substantially perpendicular with the axis of rotation about an X-axis.

21. The method of claim 19, coupling the model of the mandible to the articulating device so that a midline of the model is substantially perpendicular with the axis of rotation about a Y-axis.

22. The method of claim 19, wherein forming the model further comprises taking a first impression of a patient's mandible including a first retro molar pad of the patient and a second retro molar pad of the patient; forming a tray for taking a second impression; taking a second impression of a patient's mandible including a first retro molar pad of the patient and a second retro molar pad of the patient.

23. The method of claim 19, further comprising coupling the model of a patient's mandible to the articulating device so that an axis formed between a point on a first retro molar pad of the model and a point on a second retro molar pad of the model is substantially parallel to the axis of rotation of the articulating device;
coupling a model of the patient's maxilla to the articulating device so that the model of the maxilla fits together with the model of the mandible in a manner substantially similar to the manner in which the mandible and maxilla of the patient close together in the patient.

24. The method of claim 23, wherein coupling the model of the patient's maxilla to the articulating device so that the model of the maxilla fits together with the model of the mandible further comprises inserting a fitting into a patient's mouth to record the position of teeth, a mandible, and a maxilla relative to each other, positioning the fitting on the model of the mandible, and positioning the model of the maxilla in the fitting.

25. The method of claim 23, further comprising determining a position of an occlusal table relative to the models of the mandible and the maxilla by identifying a plane formed by the point on the first retro molar pad of the model of the mandible, the point on the second retro molar pad of the model of the mandible, and a point indicating a lower edge of at least one central incisor in the maxilla.

26. The method of claim 25, further comprising positioning at least one tooth in the base of the appliance so that an outermost surface of the at least one tooth mates with an outermost surface of an opposing tooth at the occlusal table.

27. The method of claim 25, wherein the point indicating a lower edge of at least one central incisor in the maxilla is located by identifying a location of a patient's smile line and moving from the patient's smile line toward the mandible a distance equal to a height of upper incisors desired to be visible while the patient is smiling.

28. The method of claim 27, wherein the distance equal to a height of upper incisors desired to be visible while the patient is smiling is equal to about ⅔ of a length of a tooth extending from an appliance.

29. The method of claim 27, wherein the distance equal to a height of upper incisors desired to be visible while the patient is smiling is equal to about six millimeters.

30. The method of claim 25, wherein determining the position of the occlusal table further comprises positioning a Spee curve template between the maxilla and the mandible.
